(19) United States
(12) Patent Application Publication
(10) Pub. No.: US 2001/0035501 A1
(43) Pub. Date: Nov. 1, 2001

(54) Detection of counterfeit items

(75) Inventors: Adrian Kenworth Taylor, Kirkby Lonsdale (GB); Robert Peter Stiles, Lancaster (GB)

Correspondence Address: Daniel A. Scola, Jr., Hoffmann & Baron, LLP, 6900 Jericho Turnpike, Syosset, NY, 11791, US

(73) Assignee: PANOPTIC LIMITED

(21) Appl. No.: 09/898,096

(22) Filed: Jul. 3, 2001

Related U.S. Application Data
(63) Continuation of application No. 09/252,371, filed on Feb. 18, 1999.

(30) Foreign Application Priority Data
Feb. 19, 1998 (GB) 9803396.2

(51) Int. Cl. G01N 21/64

(52) U.S. Cl. 250/461.1

(57) ABSTRACT

Miniaturized UV detection apparatus is disclosed comprising a low voltage UV bulb and detector. Bulb and detector are arranged in juxtaposition with their optical axes essentially parallel. Optical means are provided to focus the light from the bulb onto, for example, a forged banknote (bill). The paper onto which most banknotes are printed does not fluoresce under TV light but that commonly used by forgers does. If the note fluoresces, it is probably a forgery and the flouresced light is focused by the optical means onto the detector causing an output signal to be generated and passed to discriminating circuitry which operates means to accept genuine notes and reject forgeries, according to the magnitude of the signal. The PCB on which the components are mounted also acts as a screen between bulb and detector to stop light from the bulb reaching the detector. The components are located in a sleeve and are protected by insulating and thermally conducting potting compounds.

The detection apparatus described has a range of applications including in slot machines which take banknotes.

The use of filters and modulation of the light to improve the accuracy of detection are taught.

This specification relates to the use of Ultra-violet (UV) light for the detection of forged items, in particular but not exclusively, banknotes or other bills.

Many countries have relatively low denomination banknotes, or bills, and these are frequently used in slot machines to make purchases. There are various means of checking whether the bills inserted are forged. In the simplest, a dimensional check is all that is undertaken. This confirms the size and, hence, the denomination of the bill. Where higher value bills are being handled, more extensive detection means are required.

One commonly used means is to illuminate the bill with UV light, usually that part of the spectrum known as UVA. Most papers contain brightening dyes which fluoresce under UVA and the fluoresced light can be detected as shown in the example of prior art in FIG. 1. Banknotes are normally printed on a special paper which does not contain these particular dyes and so does not fluoresce. This gives a convenient means of checking for forgeries. The detection of forgeries using UV light can be either by illumination and fluorescence from one surface, or transmission of light through the paper. A further method of checking is by detection of the magnetic strip or inks commonly used in higher denomination notes.

As shown in FIG. 1, the source 5 is placed at an angle θ to illuminate 11 bill 3A. Detector 6 is placed to accept fluoresced light 12 emanating at a similar angle from bill 3A. A screen 7 separates source 5 from detector 6 so that there is no direct line of sight. Though the arrangement of source 5, detector 6 and rays 11 and 12 appears to suggest that of incident and reflected light, it is to be understood that the incident light is not reflected, but causes dyes in the paper to fluoresce and it is this light which is detected when a counterfeit note is present. FIG. 1 is a convenient arrangement as source 5 must illuminate an area of the note and detector 6 must be aligned to receive any fluoresced radiation. Bulb 16 is the conventional mains type used in prior art apparatus and is mounted in a housing with a collimating lens 17. As shown this arrangement occupies a significant volume of the slot machine and volume is at a premium in such items of equipment.

Because detector 6 is separated from bill 3A, it is possible to interfere with the fluoresced light in ways that may make counterfeit bills actually be accepted. For example, slot machines designed to operate in brightly illuminated areas can be confused if the right wavelength light is shone into inlet slot 2. While UV detection can be made reasonably reliable, this is only available in the more expensive detection systems. Thus, there is a need for a single compact source and detector module offering greater reliability at a competitive price.

According to the invention there is provided apparatus for the detection of counterfeit items comprising:

1) A source of light of a specific wavelength;

2) a detector sensitive to fluoresced light of a specific wavelength and capable of producing an output varying in relation to the intensity of the fluoresced light detected;

3) optical means to focus the incident light from the source onto a point or plane and also to concentrate fluoresced light from said point or plane onto the detector;

4) electronic means adapted to analyse the output from the detector and to produce a first signal when the output is equivalent to no, or to a negligible amount of, fluoresced light and to produce a second signal when the output is equivalent to a higher level of fluoresced light above a predetermined threshold value; and

5) accept/reject means adapted to receive signals from said electronic means and capable of accepting the item when said first signal is received and rejecting the item when said second signal is received;

characterised in that said source of light and said detector are arranged in close proximity to each other and aligned with said optical means so that the light from said source is concentrated by said optical means onto the point or plane and, when an item is placed at said point or plane, the incident source light causes it either to fluoresce or not to fluoresce according to whether it is, or is not, counterfeit, the fluoresced light being passed through said optical means to said detector to cause an output to be generated so that said accept/reject means will reject the item if it is counterfeit and accept it if it is not.

According to a first variation of the apparatus of the invention, the source, detector and optical means are optically aligned.

According to a second variation of the apparatus of the invention, the source, detector, optical means and electronic meansare all located together in a housing as a single module.

According to a third variation of the apparatus of the invention, potting compounds are used to maintain the alignments and electrical insulation between the components in the sleeve.

According to a fourth variation of the apparatus of the invention, the housing is moulded and provided with locations for some/all of the components.

According to a fifth variation of the apparatus of the invention, the specific wavelength is ultra violet light in the UVA waveband.

According to a sixth variation of the apparatus of the invention, the source is a low voltage miniature UVA bulb.

According to a seventh variation of the apparatus of the invention, the optical means includes a lens of sufficient diameter to include the optical axes of both source and detector.

According to an eighth variation of the apparatus of the invention, filters are used to select specific wavelengths of source light and/or fluoresced light.

According to a ninth variation of the apparatus of the invention, a screen is provided between the source and detector.

In a preferred embodiment of the apparatus of the invention, a miniature UVA bulb is used in conjunction with a detector of similar size so that the two may be positioned, side by side and separated by a screen to form a compact module. Ideally this module is formed inside a housing, such as a sleeve. The optical means is a lens and is provided, near the end of the sleeve, to accept the incident light from the bulb and focus it onto the detection plane. If the note in this plane is genuine, it will not fluoresce and a low, or zero, first signal will be generated which will cause the accept/reject means to accept the note. If the note is counterfeit, the paper will fluoresce and this fluorescence will shine back through the lens into the detector causing a second signal to be generated which the accept/reject means will use to reject that particular note. The feeding mechanism of the slot machine allows each note to be passed sequentially through the detection station, for exposure to the UVA light, and thence to the accept/reject station, to be accepted or rejected according to the signal from the detector.

A particular advantage of the apparatus is that the module is very compact and so will occupy only a small part of the slot machine volume. By being so compact, the detection plane can be close to the end of the sleeve so that there is less chance for external influences to generate spurious readings, or mask fluorensce. Further advantages are that the UVA bulb requires a low voltage, has a very long life and the module is factory-assembled and enclosed in the sleeve. Thus, the internal components are protected by the sleeve and method of assembly from external influences, for example, shock and vibration from a person hammering the slot machine, hence, the module is extremely reliable.

A lens is only one example of optical means applicable to the invention. It is particularly suitable for the arrangement described herein but other means are equally appropriate for other arrangements, for instance, mirrors and/or prisms can be used to change the angles of light beams, etc.

According to a tenth variation of the apparatus of the invention, means are provided to modulate the source light.

According to an eleventh variation of the apparatus of the invention, the electronic means is adapted to accept only signals from fluoresced light which are received with an appropriate modulation.

One means of avoiding external influences is for the bulb to be modulated to produce output light in a series of flashes at a particular frequency. If the detection apparatus is tuned to accept only signals at this particular frequency, there is less likelihood of external factors, such as bright day-light or somebody trying to shine a light in through the feeding slot, causing the apparatus to malfunction. Also, because the module is so compact, the optical components can be arranged to focus the light onto a point or plane very close to the end of the sleeve, i.e. it would be possible for the notes to be physically in contact with the end of the sleeve during examination, thus reducing fiber the chances of external influences affecting the reliability of the detection.

For a clearer understanding of the invention and to show how it may be carried into effect, reference will now be made, by way of example only, to the accompanying drawings in which:

FIG. 1 shows a conventional banknote counterfeit detection apparatus (Prior Art)

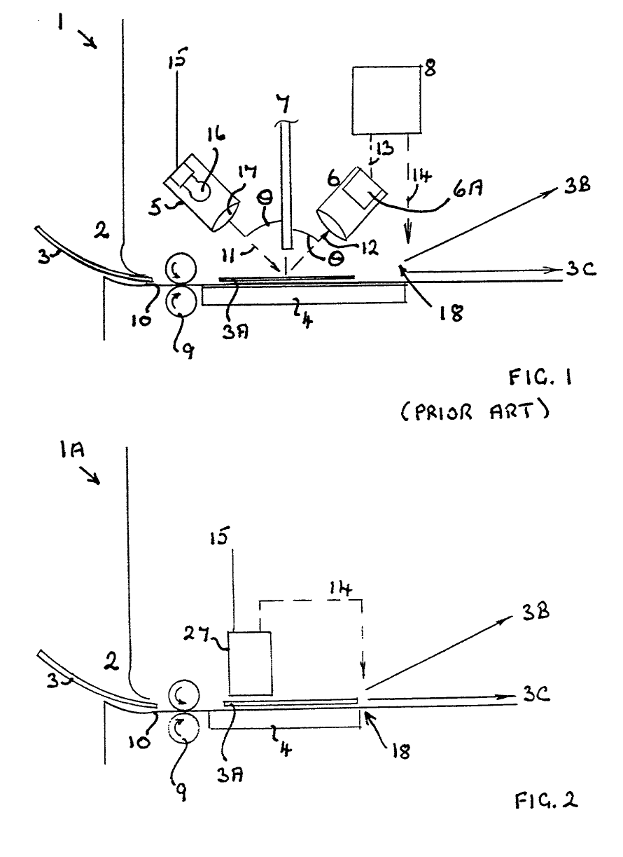

FIG. 2 shows a banknote counterfeit detection apparatus according to the invention.

FIG. 3 shows a sectional elevation through the combined UV source/detector module.

FIG. 4 shows a sectional elevation through the combined UV source/detector module along the section A A of FIG. 3.

FIG. 5 shows a sectional plan through the combined UV source/detector module along the section BB of FIG. 3.

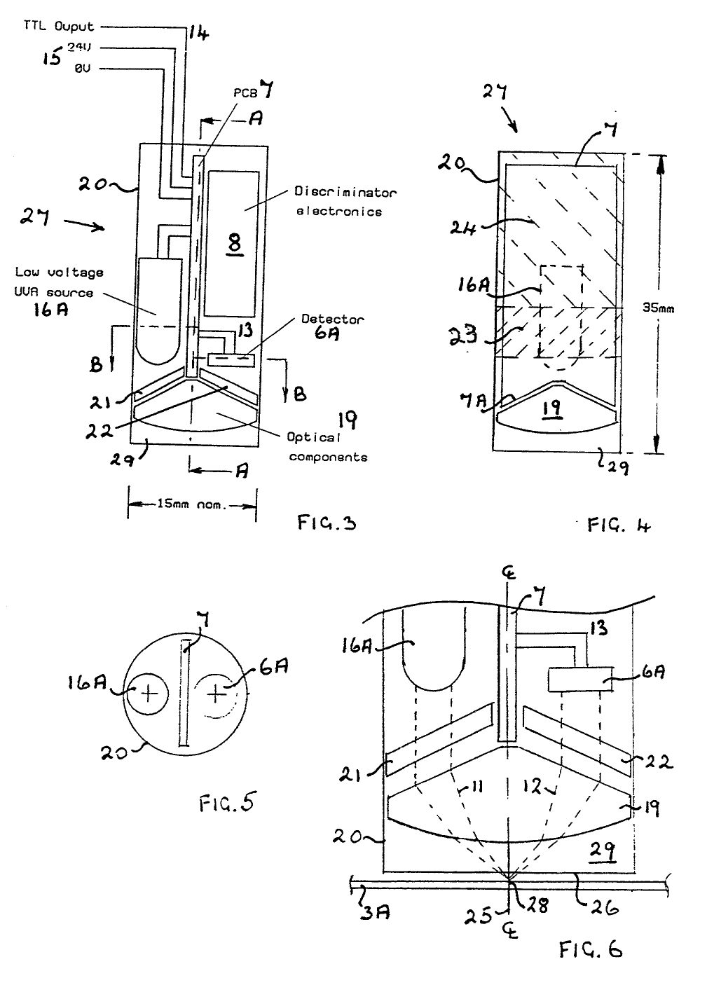

FIG. 6 shows a part sectional elevation of the combined UV source/detector module showing the optical paths relative to a note being examined.

In the following description, the same reference numeral is used for the same component or different components fulfilling an identical function. The description is written with reference to the detection of counterfeit banknotes but it will be understood that this is only one of many applications of the invention.

Referring to FIG. 1, a prior art slot machine 1 has a feed station 2. A note 3 is fed in onto surface 10 and taken by rollers 9 into the detection zone where it is held by a vacuum pad 4 against surface 10. In the detection zone, the note, here designated 3A, is subject to UVA light 11 from source 5 shining on it at an angle θ. If note 3A is a forgery, it will fluoresce and flouresced light 12 will shine at a similar angle θ into detector 6, causing an output 13 to be generated and passed to discriminator 8. If output 13 is above a predetermined threshold value, discriminator 8 produces a signal 14 to cause the note to be rejected 3B as it passes through accept/reject station 18. If no output 13 is generated, or it is below the threshold value, the note will be accepted 3C.

FIG. 2 shows how the combined source and detector module would be used in an equivalent slot machine 1A. Module 27 is shown in sectional detail in FIGS. 3, 4, 5 and 6.

Referring to FIG. 3 an UV source 16A is mounted in a tubular sleeve 20 and separated by a printed circuit board (PCB) 7 from a detector 6A. Source 16A is a small low voltage UVA bulb, for example, using a 24V power supply 15. Bulb 16A shines 11 (FIG. 6) through a bandpass filter 21 having special properties to transmit only UVA light at a wavelength of 360 nm. The light from source 16A passes through filter 21 into a lens 19. This lens is made of a material with a suitable refractive index and which transmits UVA light of the wavelengths in question. The shape of the lens focuses the source light 11 onto the banknote 3A where it will fluoresce when a forgery is present. The fluorescence 12 will shine back into lens 17 and pass through a blue glass filter 22 into detector 6A. Filter 22 will pass only light of 430-435 nm wavelength so that extraneous light does not fall onto detector 6A and give spurious readings.

The output 13 from detector 6A passes into PCB 7 and thence to discriminator 8 which has the usual accept/reject type of circuitry so that, when output 13 is above a certain predetermined threshold value, a rejection signal 14 is generated and the note is rejected 3B. If the output 13 is below the threshold value, no signal 14 is generated and the note is accepted 3C.

The sectional view in FIG. 4 shows how PCB 7 is used as a screen to stop extraneous source light 11 reaching detector 6A. The lower end 7A of PCB 7 is profiled to the shape of lens 19 to minimise the risk of stray light rays reaching the detector. FIG. 5 shows the juxtaposition of source 16A, screen 7 and detector 6A. The optical axes of both source 16 and detector 6A are marked by crosses. As shown in FIGS. 3 and 4, the size of a typical unit may be of the order of 15 mm outside sleeve diameter by 35 mm in length. This is probably smaller than the bulb 16 used in some currently available equipment and indicates the order of miniaturisation offered by the disclosure.

Source 16 and detector 6A are aligned so that their optical axes are essentially parallel to each other and to the axis of sleeve 25. Both optical axes fall in the circle covered by the diameter of lens 19 (FIG. 6). It is thus lens 19 which is the critical element of the disclosure in that it accepts input light 11 from source 16A and focuses 28 it on the banknote 3A. Though 28 is shown as a point on FIG. 6, it is preferred that rays 11 are brought to a diffuse focus 28 so that an area of note 3A moves through the detection zone, i.e. a strip across the note will be examined rather than just one single spot or a line, which might be covered with non-fluorescing printing. When fluorescence occurs, the light 12 shines from focus 28 through lens 19, filter 22 and back, as parallel rays, into detector 6A.

As shown in FIGS. 3,4 and 6, There is a space 29 between lens 19 and the end of sleeve 20. This space provides an axial distance between the lower face of lens 19 and the end of sleeve 20, which might be directly in contact with note 3A For optical reasons, focal point, or plane, 28 should be some distance away from lens 19, hence space 29. Space 29 may be either left as an empty void or filled with a suitable transparent compound similar to conventional potting compounds.

To maintain the optical alignment of the components in the module a rubber plug 23 is used as shown in the central part of sleeve 20 (FIG. 4). Above plug 23, a thermally conducting epoxy resin 24 is used to fill sleeve 20. This resin, which has the same thermal expansion characteristics as the components with which it is in contact, acts as a heat sink and dissipater to conduct the heat generated by source 16A and other components away.

An alternative to potting compounds is to use a moulded sleeve or housing 20. One feature of such mouldings is that they can be provided with location points for the components to be mounted inside; this can sometimes assist the assembly process as well as maintaining them in position afterwards.

One of the short comings of this type of UV detection system is that spurious readings can sometimes be obtained if slot machine 1 is in an area of high intensity ambient light, e.g. a bright daylight environment. Under these circumstances, it is possible to modulate the source 16A, i.e. make it flash at a predetermined frequency. Discriminator circuit 8 would then be designed to accept only signals which flashed in time with the predetermined frequency so that spurious signals would be rejected. Filters 21 and 22 are used as further means to eliminate extraneous light reaching detector 6A and producing spurious outputs 13. By restricting the light to particular wavelengths associated with the fluorescing dyes commonly added to paper, the apparatus will be more accurate in its design function.

The miniaturisation of UV detection equipment disclosed hereinabove offers a significant advance in the discovery of paper forgeries. Such equipment can now be made much more cheaply, be more compact and more reliable than hitherto. Though the teaching above has been directed towards the detection of forged banknotes, the skilled man will be aware of other applications of the technique to which the apparatus, with appropriate modifications where necessary, can be used. Possible examples are the assaying of fine metals, gem stones and jewellery, determining the authenticity of manuscripts and legal documents (either wholly or in part), testing fabrics, etc. Because the apparatus is miniaturised and uses only a low voltage bulb, it could be incorporated in to a portable testing kit.

A further important aspect of the invention is the use of low voltage power supplies 15 as these have significant safety considerations. Previously available UV bulbs and tubes require high voltage discharges to produce the fight; typically these are in the 400-600V range which can have serious Health and Safety implications.

What we claim is:

1. Apparatus for the detection of counterfeit items comprising:
1) A source of light of a specific wavelength;
2) a detector sensitive to fluoresced light of a specific wavelength and capable of producing an output vaying in relation to the intensity of the fluoresced light detected;
3) optical means to focus the incident light from the source onto a point or plane and also to concentrate fluoresced light from said point or plane onto the detector;
4) electronic means adapted to analyse the output from the detector and to produce a first signal when the output is equivalent to no, or to a negligible amount of, fluoresced light and to produce a second signal when the output is equivalent to a higher level of fluoresced light above a predetermined threshold value; and
5) accept/reject means adapted to receive signals from said electronic means and capable of accepting the item when said first signal is received and rejecting the item when said second signal is received;
characterised in that said source of light and said detector are arranged in close proximity to each other and aligned with said optical means so that the light from said source is concentrated by said optical means onto the point or plane and, when an item is placed at said point or plane, the incident source light causes it either to fluoresce or not to fluoresce according to whether it is, or is not, counterfeit, the fluoresced light being passed through said optical means to said detector to cause an output to be generated so that said accept/reject means will reject the item if it is counterfeit and accept it if it is not.

2. Apparatus for the detection of counterfeit items as claimed in claim 1 wherein the source of light is a low voltage UV lamp.

3. Apparatus for the detection of counterfeit items as claimed in claim 2 wherein the specific wavelength is in the UVA band.

4. Apparatus for the detection of counterfeit items as claimed in claim 3 wherein the optical means includes a lens transparent to UVA light.

5. Apparatus for the detection of counterfeit items as claimed in claim 4 wherein the optical means includes a mirror or prism transparent to UVA light.

6. Apparatus for the detection of the counterfeit items as claimed in claim 5 wherein the electronic means includes the circuitry to discriminate between signals above or below a pre-set threshold value.

7. Apparatus for the detection of counterfeit items as claimed in claim 6 wherein the source of light, detector and optical components have their axes optically aligned.

8. Apparatus for the detection of counterfeit items as claimed in claim 5, wherein the diameter of the lens is sufficiently large to include the optical axes of both source of light and detector.

9. Apparatus for the detection of counterfeit items as claimed in claim 1 wherein the source of light, detector, optical means an electronic means are compactly located in a protective housing.

10. Apparatus for the detection of counterfeit items as claimed in claim 9 wherein the source of light, detector, optical means an electronic means are held in position in the protective housing by a potting compound.

11. Apparatus for the detection of counterfeit items as claimed in claim 10 wherein the potting compound includes a thermally dissipative material.

12. Apparatus for the detection of counterfeit items as claimed in claim 11 wherein the protective housing is a moulded item.

13. Apparatus for the detection of counterfeit items as claimed in claim 12 wherein the moulded protective housing is provided with a site for the location of the component.

14. Apparatus for the detection of counterfeit items as claimed in claim 1 wherein optical filters are included to select particular wavelengths of either the incident light or the fluoresced light.

15. Apparatus for the detection of counterfeit items as claimed in claim 1 wherein a screen is provide between the source of light and the detector.

16. Apparatus for the detection of counterfeit items as claimed in claim 15 wherein the screen is printed circuit board.

17. Apparatus for the detection of the counterfeit items as claimed in claim 1 wherein the source of light is modulated to flash at a predetermined frequency.

18. Apparatus for the detection of counterfeit items as claimed in claim 17 wherein the electronic means is adapted to accept only signals modulated at the source light frequency.

19. Apparatus for the detection of counterfeit items as claimed in claim 1 including a feeding station for feeding items into the apparatus, means to pass the items to an detection station where they are subject to detection, further means to pass the items to an accept/reject station and means to accept or reject said items in accordance with the result of the detection.

20. Apparatus for the detection of counterfeit items as claimed in claim 1 wherein a axial distance is provide between the surface of the lens and the item to be examined.
